(19) United States
(12) Patent Application Publication
(10) Pub. No.: US 2018/0128425 A1
(43) Pub. Date: May 10, 2018

(54) LG MODULE AND A MARINE VESSEL COMPRISING A LG MODULE

(71) Applicant: GVA CONSULTANTS AB, Göteborg (SE)

(72) Inventors: David ANDRE, Göteborg (SE); Henning LUNDIN, Göteborg (SE)

(21) Appl. No.: 15/579,176

(22) PCT Filed: Jun. 5, 2015
(86) PCT No.: PCT/EP2015/062566

§ 371 Date: Dec. 1, 2017

(51) Int. Cl. F17C 13/02; F17C 1/00; F17C 13/12; B63B 25/14

(52) U.S. Cl. CPC F17C 13/02; F17C 2265/07; F17C 13/126; B63B 25/14; F17C 2205/0332; F17C 2221/035; F17C 2221/033; F17C 2260/042; F17C 2260/021; F17C 2270/0105; F17C 2205/0176; F17C 2205/0107; F17C 2227/0304; F17C 2227/0318; F17C 2250/032; F17C 2265/066; F17C 1/002

(57) ABSTRACT

A LG module for a marine vessel (1), said LG module (10) comprising a support structure for loading and unloading said LG module (10) onto said marine vessel (1), at least one LG tank (12) and a LG gas processing unit (13) for processing LG to fuel, said fuel fulfilling the requirements of an engine of said marine vessel (1).

### TECHNICAL FIELD

The invention pertains to a LG module such as a LNG module for a marine vessel. The LG module is adapted to locally convert the LG temporarily stored in a tank to fuel suitable for the marine vessel.

### BACKGROUND

Liquefied natural gas, LNG, is produced by cooling natural gas and purifying it to desired methane content, such as 95% or more. Liquefaction is achieved by cooling the purified natural gas to a temperature of −162° C. or below. When transporting, storing and using LNG as a fuel, the cryogenic temperature associated with LNG systems gives rise to safety considerations. Although LNG is kept in generally non-pressurized, highly insulated tanks, the great temperature differential between the interior of the tank and the ambient air causes the temperature in the tank to rise over time, resulting in fuel evaporation and pressure build-up inside the tank. LNG escaping from an LNG system and mixing with air in a confined space may under certain conditions be an explosion hazard or may cause asphyxiation. A further hazard is that people and equipment may be injured by exposure to the extremely cold cryogenic substance. For these reasons, handling of LNG is subject to extensive safety regulations including requirements for good ventilation and safety zones surrounding LNG equipment.

Fuelgarden recently introduced a range of portable LNG refueling solutions in which a full isotank can be placed and secured directly onto the deck of a suitable vessel in exchange for the empty one. The system has drawbacks however as it requires the vessel to be specifically adapted to have LNG as fuel and the deck space cannot be used for other purposes.

It is an object of the invention to provide for a marine vessel having an improved fuel system, in particular to improve the flexibility of the fuel system of the marine vessel.

### SUMMARY

According to the invention there is offered an LG module for a marine vessel. The LG module comprises a support structure for loading and unloading the LG module onto the marine vessel. At least one LG tank and a LG gas processing unit for processing LG to fuel, the fuel fulfilling the requirements of an engine of the marine vessel.

The liquefied gas, LG, may be liquefied hydro carbon gas, such as liquefied natural gas also referred to as LNG, liquefied propane/butane gas also referred to as LPG and/or liquefied ethylene gas also referred to as LEG. It is preferable that the LG module is a LNG module.

In a module based marine LG fuel system modules may be lifted and installed on board a vessel when needed. The modular units may be installed on the vessel and connected to each other and to other assembly modules or equipment on the vessel such as a pre-installed vent line system, a power system, etc. By providing the LG fuel system in the form of modular components, deck load capacity and deck area of the vessel can be utilized for other purposes when an LG fuel system module is not installed. A vessel may be prepared for installing an LG fuel system module at a later stage. A LG fuel system module, also referred to as a LG module, may be moved between different vessels and may be shared by different vessels if the need to operate on LG is intermittent. As set out herein, the marine vessel may be a semi-submersible vessel or a marine vessel with conventional hull form, i.e. monohull or alternatively a multihull vessel such as a catamaran or a trimaran. The modules are typically intended to be placed on an open deck of the vessel. The module may be split in sub-modules or combined as found practical.

The more functions or add-ons that may be incorporated in the module, either as sub-modules or as an integrated unit of the module, the less the marine vessel needs to be prepared and the more space can be saved on the marine vessel.

The LG module may comprise a pressure build up unit. The pressure build up unit is arranged to pressurize the at least one LG tank and/or a fuel system of the marine vessel connected to the at least one LG tank.

The LG module may comprise at least one pressure relief valve. If the LG module comprises a pressure relief valve, space can be explicitly dedicated on the module for the safety area surrounding the pressure relief valve. Other structures of the marine vessel may be less dependent on the position of such safety area.

The LG module may comprise a connection for connecting the LG gas processing unit to the fuel system of the marine vessel. This provides an easy connectable module to the marine vessels own fuel system. The fuel system is preferably associated with the propulsion system of the marine vessel, and/or power generation system.

The LG module may comprise a LG bunkering manifold for bunkering LG, this permit the LG tank of the LG module to be refilled when appropriate. It may also permit other connections to be available for the marine vessel. The LG bunkering manifold may thus be provided with additional connections simply to serve additional bunkering to the marine vessel.

The LG module may comprise a bunkering control station adapted to communicate with the marine vessel, preferably communicating with monitoring, safety and/or control systems of the marine vessel and/or on a bunker supply unit such as a bunker supply vessel, bunker supply terminal or the like. The LG module can by this feature easy communicate with the marine vessel and/or the bunker supply unit and does not require additional manipulation of the marine vessel itself.

The module further may comprise a cabin, the cabin providing a safe area for at least one person. The cabin may be ventilated and comprise an air lock for example. Again, the handling of LG maybe hazardous and by providing a cabin on the LG module, the marine vessel does not need to dedicate space for this.

The LG module may comprise a cryogenic spillage protection portion, such as a cryogenic spillage protection floor. The cryogenic spillage protection portion is adapted to protect the hull and/or deck of the marine vessel from cryogenic spillage. Cryogenic spillage may be very hazardous as it may affect the structural integrity of the material upon which it is spilled. It is thus important to protect the hull and the deck of the marine vessel from such spillage.

It is also within the boundaries of the present invention to provide a marine vessel comprising at least one LG module according to any one of the preceding claims, the marine vessel is preferably a semi-submersible vessel.

The LG module, which also can be referred to as a LG fuel module, is preferably a LG module system comprising one or more sub-modules.

The LG module may be a Liquefied hydro carbon gas module such as a LNG, LPG, and/or or LEG module. It is preferable that the LG module is a LNG module. As is understandable, the LG tank is then a LNG tank and the LG gas processing unit is of course a LNG gas processing unit for processing LNG, and so forth.

### BRIEF DESCRIPTION OF THE DRAWINGS

The present invention will be further explained hereinafter by means of non-limiting examples and with reference to the appended drawing wherein:

FIG. 1 shows a side view of a semisubmersible vessel with an LNG fuel system.

### DETAILED DESCRIPTION OF PREFERRED EMBODIMENTS

It is to be understood that the drawings are schematic and that the parts of the illustrated marine vessel are not shown in detail and not necessarily drawn to scale. The semi-submersible vessel shown in the figures is provided as an example only and should not be considered limiting to the invention. As set out herein, the LNG fuel system of the invention may be used on other types of marine vessels of any type such as a vessel of the conventional monohull or multihull type. Furthermore, the invention is applicable to marine vessels used for other purposes than drilling, such as oil and gas exploration, vessels for offshore storage and processing of hydrocarbons, etc. Accordingly, the scope of the invention is determined solely by the appended claims.

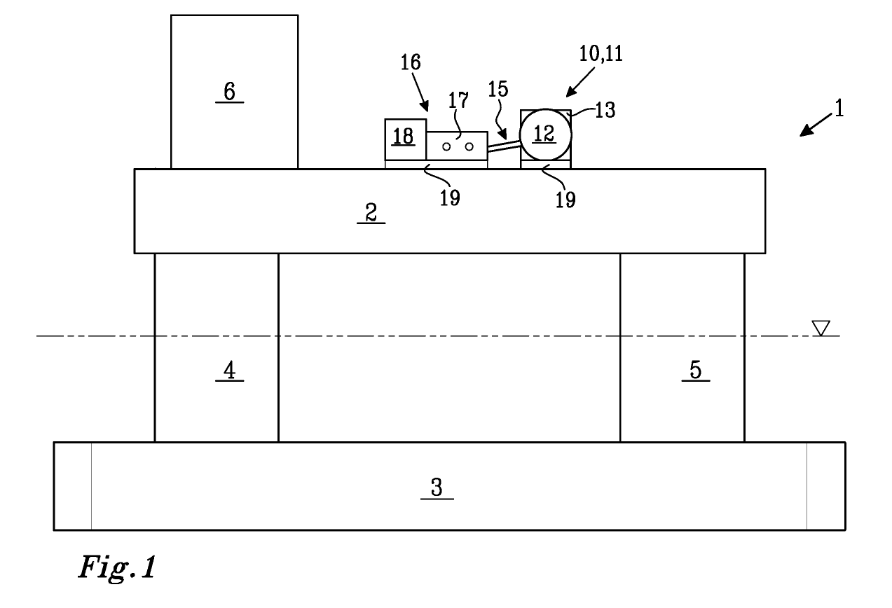

The marine vessel, in this case a semi-submersible vessel 1, shown in FIG. 1 is an offshore drilling platform with a main deck 2. The side view of the semi-submersible vessel 1 in FIG. 1 shows a pontoon 3 of a lower pontoon structure and two columns 4, 5 which extend vertically upward from the pontoon 3 to the main deck 2. The main deck 2 is arranged for supporting such functions and items as cranes, crew quarters, a heli-pad, lifeboats, racks for horizontally storing drill pipes and riser pipes etc. Such structures and items are not shown in FIG. 1. A drilling deck 6 is arranged above the main deck 2 and supports a derrick (not shown).

An LNG fuel system 10 is installed on the main deck 2. In the example shown in FIG. 1, the LNG fuel system 10 is a fuel supply system for supplying regasified natural gas to the power system of the semi-submersible vessel 1. As will be described in greater detail below, the LNG fuel system 10 is provided to the semi-submersible vessel 1 as a LNG module 11.

By the term “module” used herein is meant a self-contained component or system, which is interchangeable and adapted to be mated via a well-defined interface existing on the other component. Preferably the module can be mated without hot work such as welding.

The LNG module 11 comprises an LNG tank 12 for temporary storage of LNG before conversion to fuel for the semi-submersible vessel 1. The module further comprises a LNG gas processing unit 13 for regasifying the temporary stored LNG to fuel gas in accordance with the marine vessel engine fuel requirements.

As set out herein, the LNG module 11 may be fully or partially enclosed in a protective barrier structure which is appropriately ventilated. The LNG module 11 may also be provided with a ventilation system, such as a stand-alone ventilation system or it may be connected to the ventilation system of the semi-submersible vessel 1. The enclosure may protect structural steel from cryogenic spillage for example. The module 11 is thus provided with a cryogenic spillage protection portion 19.

The LNG storage tank 12 and the gas processing unit 13 are connected by piping 15 to a bunkering unit 16. The LNG module 11 may also comprise further equipment such as a bunkering control cabin with necessary control systems for bunkering and connections for interfacing with the semi-submersible vessel's 1 monitoring and control systems and optionally safety systems. A control cabin, or a cabin, may be a safe area which is equipped with a ventilation system which may be a stand-alone ventilation system or a ventilation system connected to the ventilation system of the semi-submersible vessel 1.

The LNG tank 12 and gas processing unit 13 and the LNG bunkering unit 16 shown in FIG. 1 are provided as modular components of the LNG fuel system. They may be provided as individual module connectable to each other or as a single module connectable with the semi-submersible vessel 1. The LNG tank 12 and gas processing unit 13 are arranged on a first module frame which supports the equipment of the LNG tank 12 and gas processing unit 13 and which is mounted on a matching foundation on the deck 2 of the semi-submersible vessel 1.

The LNG bunkering unit 16 is arranged on a second module frame which supports the equipment of the LNG bunkering unit 16 and which is mounted on a matching foundation on the deck 2 of the semi-submersible vessel 1.

In a module based marine LNG fuel system, such as an LNG fuel module, modules may be lifted and installed on board a vessel when needed. The modular units may be installed on the vessel and connected to each other and to other assembly modules or equipment on the vessel such as a pre-installed vent line system, a power system, etc.

By providing the LNG fuel system in the form of modular components, use of the deck load capacity and the deck area of the vessel can be optimized and deck area can be utilized for other purposes when an LNG fuel system is not installed. A vessel may be prepared for installing an LNG fuel system module at a later stage. A LNG fuel system module may be moved between different vessels and may be shared by different vessels if the need to operate on LNG is intermittent. In addition, the modular system allows the capacity of the LNG fuel system to be increased or decreased as required.

The modules may advantageously be structurally designed to be lifted and also include means for attaching lifting slings or similar. The LNG module 11 should thus be provided with a support structure for load and/or unloading the LNG module 11.

The LNG module is intended to be pre-commissioned, class approved and ready to be put in service as soon as it is connected and fastened to the deck 2 of the semi-submersible vessel 1. The LNG module 11 preferably include the hard- (PLC) and software for the control and monitoring of the functions included in the LNG module. If found suitable, the hard- and software may be installed in the LNG module and shared between the different modules of the LNG fuel system.

The LNG module is preferably a standalone plug and play LNG module with the purpose to temporary store LNG for use as fuel and with the purpose to process LNG to fuel conditions.

The LNG tank 12 is a type C tank (pressure vessel) and the pressure of the gas supply may be controlled by controlling the tank pressure. The LNG tank 12 may however be of another type than type C tank. The LNG tank 12 may be equipped with pressure relief valves (PRV) either connected to a ventilation system included in the LNG module 11 or with possibility to connect the PRVs to a pre-installed ventilation system on board the semi-submersible vessel 1.

The gas processing unit 12 may be connected to the LNG tank 12. The gas processing unit 12 is configured to process the temporary stored LNG to fuel gas suitable for the engines. The gas processing unit 12 contains all (single barrier) connections to the LNG tank 12 interior. The gas processing unit 12 may be ventilated according to rules and regulations, typically 30 air changes per hour.

The gas processing unit 12 may be heated either by thermal media supplied from the semi-submersible vessel's 1 machinery systems, or by sea-water or alternatively by electricity. The gas processing unit 12 may thus contain evaporators and/or heaters for processing the LNG to fuel at engine required conditions for example with respect to temperature and pressure.

The LNG module 11 should preferably be able to safely contain cryogenic spillage.

The LNG module 11 may have one or more interfaces such as one or more of the following interfaces for securing the LNG module to the deck 2, connection for electricity from the semi-submersible vessel 1 to the LNG module 11, connection for signals for control and monitoring between the semi-submersible vessel 1 and the LNG module 1, connection for sea water and/or thermal media, connection for gas fuel piping to the engine of the semi-submersible vessel 1, connections for bunkering of LNG from a bunkering module and for return of vapour to the bunkering module, connections for inert gas either to an inert gas module or to inert gas generated on board by vessel's fixed systems, connections for relief valve vent lines between the LNG module 11 and the semisubmersible vessel 1, connection for hazardous ventilation inlets/outlets.

As mentioned above, the LNG bunkering unit 16 is arranged on a second module frame which supports the equipment of the LNG bunkering unit 16 and which is mounted on a matching foundation on the deck 2 of the semi-submersible vessel 1. The LNG bunkering unit 16 may however be assimilated with the LNG tank 12 and the gas processing unit 13 module. The LNG module 11 disclosed herein may thus be formed by one or more sub-modules.

The LNG bunkering unit 16 comprises both a bunker manifold 17 and the bunker control station 18. The LNG bunkering unit 16 may be a standalone “plug and play” module and may serve as a connection point between the bunker manifold 17 and the semi-submersible vessel 1 itself. One purpose may be to distribute bunkered LNG to the connected LNG tanks 12 and to allow for control and monitoring of the bunkering process.

The bunkering manifold 17 has connections for bunkering hose(s) and vapour return hose(s). The LNG bunkering unit 16 may also include means for protection of structural steel, equipment and personnel from cryogenic spillage. The LNG bunkering unit 16 may also include fixed firefighting system such as powder.

The bunkering process can be monitored and controlled from the bunkering control station 18. The bunker control station 18 is in the shown embodiment a cabin comprising a ventilated enclosed compartment preferably with an air lock.

LNG bunkering unit 16 may have one or more interfaces such as one or more of the following interfaces for securing of the LNG bunkering unit 16 to the deck 2, connection for electricity from the semi-submersible vessel 1 to the LNG bunkering unit 16, connection for signals for control and monitoring between semi-submersible vessel 1 and the LNG bunkering unit 16 and between other modules, connections for piping for transferring bunkered LNG from LNG bunkering unit 16 the LNG tank 12 and for return of vapour from the LNG tank 12, connections for inert gas either to an inert gas module or to inert gas generated on board by vessel's fixed systems, pipe/flange connections for bunker barge or terminal, emergency shut down (ESD) signals between bunker supplying unit and LNG bunkering unit 16.

The LNG module 11 may also be provided with an inert gas generator unit.

The inert gas generator unit has the purpose to generate inert gas for purging of pipes in the semi-submersible vessel 1 LNG fuel system and for purging of bunkering lines and vapour return lines in the LNG bunkering unit 16, and/or for purging of the LNG tank 12.

Inert gas generator unit may have one or more interfaces such as one or more of the following interfaces for, securing of the inert gas generator unit to the deck 2, connection for electricity from semi-submersible vessel 1 to the inert gas generator unit, connection for signals for control and monitoring, connections for distribution of inert gas to consumers e.g. on the semi-submersible vessel 1 or on other vessels or terminals, to mention a few.

The semi-submersible vessel 1 has been arranged to permit the docking of the LNG module 11 by pipes, ventilation, and/or pressure relief pipes.

The LNG module 11 is preferably used as a secondary fuel system for the propulsion of the marine vessel, power generation and/or electricity generation on the marine vessel.

1. A LG module for a marine vessel (1), said LG module (10) comprising a support structure for loading and unloading said LG module (10) onto said marine vessel (1), at least one LG tank (12) and a LG gas processing unit (13) for processing LG to fuel, said fuel fulfilling the requirements of an engine of said marine vessel (1).

2. The LG module (10) according to claim 1, wherein said LG module further comprises a pressure build up unit, said pressure build up unit is arranged to pressurize said at least one LG tank (12) and/or a fuel system of said marine vessel (1) connected to said at least one LG tank (12).

3. The LG module (10) according to claim 1, wherein said LG module (10) further comprises at least one pressure relief valve.

4. The LG module (10) according to claim 1, wherein said LG module (10) comprises a connection for connecting said LG gas processing unit (13) to the fuel system of said marine vessel (1).

5. The LG module (10) according to claim 1, wherein said LG module (10) comprises a LG bunkering manifold (17) for bunkering LG.

6. The LG module (10) according to claim 1, wherein said LG module (10) comprises a bunkering control station (18) adapted to communicate with said marine vessel (1) and/or a bunker supplying unit, preferably the monitoring, safety and/or control systems of said marine vessel (1) and/or said bunker supplying unit.

7. The LG module (10) according to claim 1, wherein said LG module (10) further comprises a cabin, said cabin providing a safe area for at least one person.

8. The LG module according to claim 1, wherein said LG module (10) comprises a cryogenic spillage protection portion (19), such as a cryogenic spillage protection floor, wherein said cryogenic spillage protection portion (19) is adapted to protect the hull and/or deck of said marine vessel from cryogenic spillage.

9. The LG module (10) according to claim 1, wherein said LG module (10) is a LG module system comprising one or more sub-modules.

10. The LG module (10) according to claim 1, wherein said LG module is a Liquefied hydro carbon gas module such as a LNG module, LPG module, and/or or LEG module.

11. A Marine vessel (1), comprising:
a marine vessel (1) being one of: a semi-submersible vessel (1), a monohull vessel, and a multi hull vessel; and
a LG module (10) comprising a support structure for loading and unloading said LG module (10) onto said marine vessel (1), at least one LG tank (12) and a LG gas processing unit (13) for processing LG to fuel, said fuel fulfilling the requirements of an engine of said marine vessel (1).

12. The marine vessel (1) according to claim 11, wherein said marine vessel is a ship, an oil drilling vessel, a heavy lift vessel, pipe laying vessel, oil production vessel, gas production vessel, accommodation vessel, bunker vessel, cargo vessel, passenger vessel, platform supply vessel, fishing vessel, anchor handling vessel, sub-sea construction vessel, seismic survey vessel, research vessel, naval vessel, construction vessel, diving support vessel, or a rescue vessel.
